(19) United States
(12) Patent Application Publication
(10) Pub. No.: US 2016/0265580 A1
(43) Pub. Date: Sep. 15, 2016

(54) LIGHTWEIGHT, STIFF IN COMPRESSION, CONNECTING ROD FOR A RECIPROCATING PISTON ENGINE

(71) Applicant: FORD GLOBAL TECHNOLOGIES, LLC, Dearborn, MI (US)

(72) Inventors: Larry Dean Elie, Ypsilanti, MI (US); Timothy J. Potter, Dearborn, MI (US)

(21) Appl. No.: 14/656,154

(22) Filed: Mar. 12, 2015

(51) Int. Cl. F16C 7/02; B22F 5/00; B22F 7/08; B22D 19/02

(52) U.S. Cl. CPC F16C 7/023; B22D 19/02; B22F 5/00; B22F 7/08

(57) ABSTRACT

A connecting rod is provided for a reciprocating piston engine. The connecting rod includes a body having an embedded structural tube for increasing the stiffness of the connecting rod.

### TECHNICAL FIELD

This document relates generally to the motor vehicle field and, more particularly, to a lightweight connecting rod incorporating an embedded structural tube for increased stiffness in compression.

### BACKGROUND

In a reciprocating piston engine, a connecting rod connects a piston to a crankshaft so that the reciprocating motion of the piston may be converted into a rotating motion of the crankshaft. As should be appreciated, the connecting rod is rigid so that it will transmit either a push or a pull and thereby rotate the crankshaft through both halves of its revolution.

Modern connecting rods are designed to be very light weight in order to reduce reciprocating mass energy losses. Some are made from aluminum, powder metal or powder forged. In others, the powder is an iron alloy. Sintered powder has been thought to provide sufficient strength but be lighter and less expensive to produce than a solid iron alloy or a cast iron connecting rod due to the porosity of the resultant material. Other lightweight connecting rods utilize titanium or other exotic lightweight alloys but at a cost penalty.

During operation of the reciprocating piston engine, the connecting rod is subject to relatively high centrifugal force. As a result, connecting rod stretch is a limiting factor for high-speed engine operation. Recent measurements further suggest the connecting rods are deflecting far more than had been expected at lower engine operating speeds. Data shows the losses for current powder forged aluminium rods are very significant: that is, a significant fraction of a millimeter each turn when the piston is under high compression loads. The same is true for other inexpensive alloys.

It should be appreciated, that connecting rod deformation upon cylinder firing causes a loss in engine compression and may in fact be a loss of energy to heat. Connecting rod deformation may also lead to a loss in fuel economy.

This document relates to a new connecting rod for a reciprocating piston engine having a body incorporating an embedded structural tube for increasing the stiffness of the connecting rod, limiting the deformation/stretch/compression of the connecting rod even at high compression loads and thereby improving engine compression ratio and fuel economy. By reducing stretch, the new connecting rod also makes a more secure position limit allowing for higher speed engine operation while protecting the piston, the valves, the spark plug and the injector.

### SUMMARY

In accordance with the purposes and benefits described herein, a connecting rod is provided for a reciprocating piston engine. That connecting rod comprises a body including an embedded structural tube for increasing the stiffness of the connecting rod. More specifically, the body includes a piston end, a crankshaft end and an intermediate section between the piston end and the crankshaft end. The structural tube extends from the piston end to the crankshaft end in the intermediate section.

In one possible embodiment, the structural tube includes an inner diameter of between about 0.2 mm and about 2.0 mm. Further, the structural tube has a Young's modulus Y₁ and the body has a Young's modulus Y₂ where Y₁>Y_{2.}

In one possible embodiment, the body of the connecting rod is made from a material having a Young's modulus Y₂ of between about 500 and about 200 GPa.

In one possible embodiment, the structural tube is made from a ceramic oxide. That ceramic oxide may be selected from a group of ceramics consisting of ceramic oxides, ceramic non-oxides and composites. Ceramic oxides useful for this purpose include aluminum oxide, beryllium oxide, cerium oxide, zirconium oxide, silicon oxide, quartz and mixtures thereof.

Ceramic non-oxides useful for this purpose include carbides, borides, nitrides and silicides as well as combinations thereof.

Composite material useful for this purpose includes a matrix binder and a reinforcing element. That reinforcing element may be selected from a group of materials consisting of reinforcing fibers, graphite fibers, glass fibers, carbon fibers, carbon nanotubes, and combinations thereof. Further, the body may be made from a material selected from a group consisting of aluminum, aluminum alloy, iron, iron alloy, steel, tungsten alloy steel and combinations thereof.

In accordance with an additional aspect, a method is provided for producing a connecting rod for a reciprocating piston engine. That method may be broadly described as comprising a step of forming a body of the connecting rod with an embedded structural tube thereby increasing stiffness of the connecting rod. In one possible embodiment, that forming step is completed by casting. In another possible embodiment, that forming step is completed by sintering.

In the following description, there are shown and described several preferred embodiments of the connecting rod. As it should be realized, the connecting rod is capable of other, different embodiments and its several details are capable of modification in various, obvious aspects all without departing from the connecting rod as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the connecting rod and together with the description serve to explain certain principles thereof. In the drawing figures:

FIG. 1 is a front elevational view illustrating the connecting rod including the embedded structural tube for increasing the stiffness of the connecting rod.

FIG. 2 is a cross-sectional view along line 2.2 of FIG. 1.

FIG. 3 is an exploded perspective view illustrating one approach for casting the connecting rod with the embedded structural tube as illustrated in FIG. 1.

FIG. 4 is a detailed view of the tube cap utilized when casting the connecting rod as illustrated in FIG. 3.

FIG. 5 illustrates the structural tube with end caps in place, positioned in the mold for casting.

Reference will now be made in detail to the present preferred embodiments of the connecting rod, examples of which are illustrated in the accompanying drawing figures.

### DETAILED DESCRIPTION

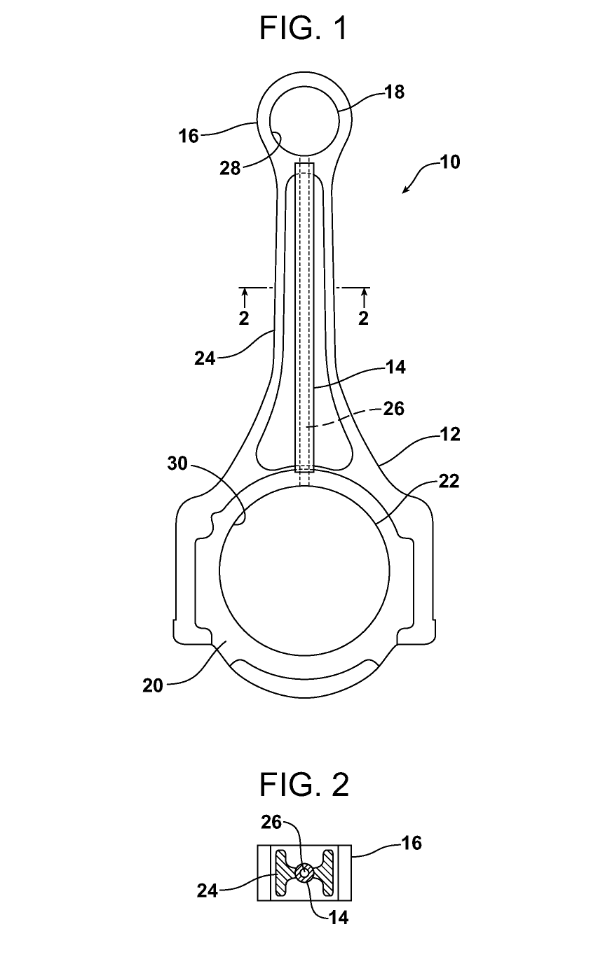

Reference is now made to FIGS. 1 and 2 illustrating a connecting rod 10 for a reciprocating piston engine. The connecting rod comprises a body 12 including an embedded structural tube 14 for increasing the stiffness of the connecting rod 10. As illustrated, the body 12 includes a piston end 16 having an opening 18 for receiving the wrist pin (not shown) of a piston. The body 12 further includes a crankshaft end 20 having an opening 22 for engaging a crankshaft (not shown). Further, the body 12 includes an intermediate section 24 extending between the piston end 16 and the crankshaft end 20.

In the illustrated embodiment, the structural tube 14 extends from the piston end 16 to the crankshaft end 20 in the intermediate section 24. In one possible embodiment, the structural tube 14 includes a continuous central opening 26 having a diameter of between about 0.2 mm and about 2.0 mm. This central opening 26 functions as a pathway for delivering oil to both the wrist pin bearing surface 28 and crankshaft bearing surface 30 of the connecting rod 10. While the concept of providing an oil tube in a connecting rod is old in the art (see, for example, U.S. Pat. No. 3,482,467 to Volkel), the prior art oil tubes are not structural and do not increase the stiffness of the connecting rod. In fact, if anything, they decrease the stiffness.

Thus, in accordance with a significant aspect, the structural tube 14 is made from a material specifically selected to increase the stiffness of the connecting rod 10. Thus the structural tube 14 has a Young's modulus Y₁ and the body 12 has a Young's modulus Y₂ where Y₁>Y_{2.}

The structural tube 14 may be made from a number of different materials. Useful materials include, but are not necessarily limited to, ceramic oxides, ceramic non-oxides and composite materials. Useful ceramic oxides include, but are not necessarily limited to, aluminum oxide, beryllium oxide, cerium oxide, zirconium oxide, silicon oxide, quartz and mixtures thereof. Useful ceramic non-oxides include but are not necessarily limited to carbides, borides, nitrides, silicides and combinations thereof. Ceramics of aluminum and silicone carbide, boride and nitride are just some of the possible ceramic non-oxides useful for the construction of the structural tube 14.

Useful composite materials include a matrix binder and a reinforcing element. Reinforcing elements useful for the composite material may be selected from a group of materials consisting of reinforcing fibers, graphite fibers, glass fibers, carbon fibers, carbon nanotubes and combinations thereof.

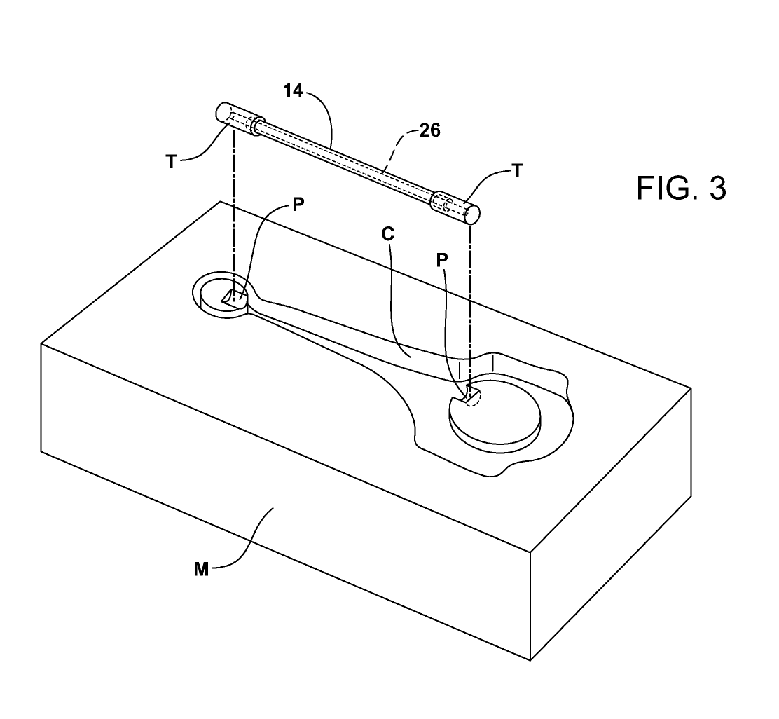

The body 12 of the connecting rod 10 may be made from any appropriate material for the construction of a connecting rod including, but not necessarily limited to, aluminum, aluminum alloy, iron, iron alloy, steel, tungsten alloy steel and combinations thereof. Significantly, the material selected for the construction of structural tube 14 must have a Young's modulus Y₁ greater than the Young's modulus Y₂ of the body 12. Further, the material selected for the structural tube 14 must be compatible with and have a higher melting point than the material used to form the body 12 so that the structural tube will maintain its structural integrity during the casting of the body 12. Further, the material from which the structural tube 14 is made must have good wetting properties to provide good adhesion between the structural tube and the material from which the body 12 is cast. The connecting rod 10 is produced by forming the body 12 of the connecting rod with the embedded structural tube 14 in place. This may be done by casting, sintering or forging. A casting operation is illustrated in FIGS. 3-5.

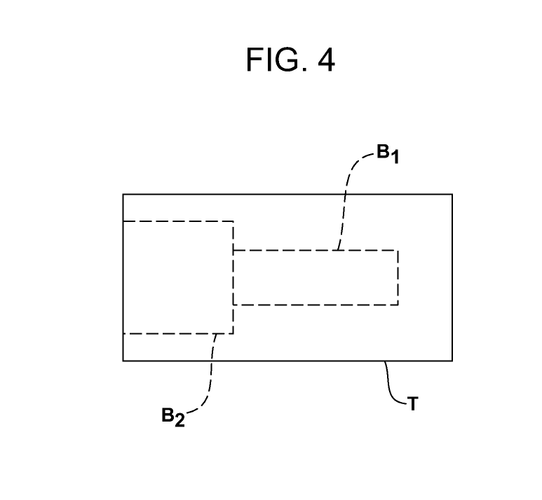

As illustrated in FIG. 3, a mold tool M includes a connecting rod forming cavity C with two cap pockets P. The structural tube 14 includes a tube cap T at each end to close off the lumen 26 as illustrated in FIG. 4, each tube cap T includes a first bore B₁ roughly corresponding in diameter to the lumen 26 and a counterbore B₂ having a diameter substantially corresponding to the outer diameter of the structural tube 14. Each tube cap T is made from a material compatible with material from which the body 12 is to be casted. In one possible embodiment, the materials are the same.

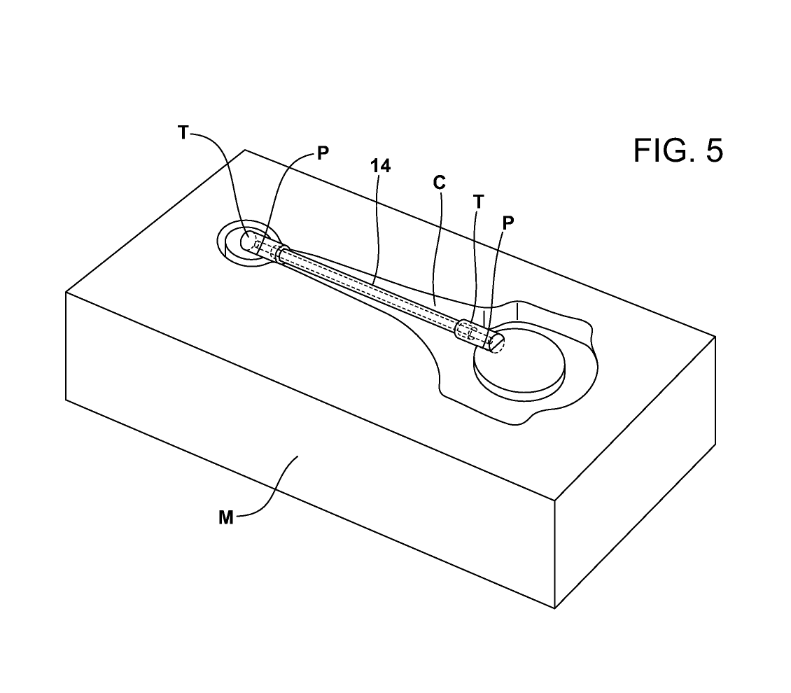

As illustrated in FIG. 5, the capped structural tube 14 is positioned in the cavity C of the mold tool M by placing the tube caps T in the cap pockets P. The mold tool M is then closed with a second cooperating mold tool (not shown) to complete the mold and the molten cast materials are introduced into the cavity C so that the structural tube 14 is embedded in place in the cast intermediate section 24 extending between the piston end 16 and the crankshaft end 20. Since tube caps T are made of the same material as the mold material introduced into the mold M to cast the body 12, the caps become a unitary part of the connecting rod 10.

In both lost-foam casting and salt casting, a form is made and a cast potting material is poured into the form as a liquid. In both cases, the structural tube 14 may be laid in the form with enough of the ends protruding to allow it to be held firmly in place until the potting material is added. When the potting material dries or cures, the new form is removed ready for the aluminum or other cast material to be poured into the pot. In the case of the lost-foam casting, the foam dissociates on contact with the molten metal and the structural tube 14 is permanently embedded in the resulting connecting rod 10. In the case of salt casting, the salt member containing the structural tube 10 lays in the cast form and the aluminum or other material is poured into the form anchoring the structural tube. The salt is rinsed off. In the lost-form casting, nearly the entire structural tube 14 is embedded in the foam while in contrast, in the salt casting, only enough of the structural tube is embedded in the salt to hold the part in place during casting.

The connecting rod 10, incorporating a structural tube 14 in the body 12 thereof provides a number of benefits and advantages. The connecting rod 10 is very light weight but also provides increased stiffness due to the structural tube having a Young's modulus Y₁ greater than the Young's modulus Y₂ of the body 12 of the connecting rod. This increase in stiffness reduces the compression and elongation or stretch exhibited by the connecting rod in response to centrifugal forces particularly at higher speeds and high compression loads. The resulting more limited deformation functions to minimize or eliminate compression losses thereby increasing engine power and also fuel economy. Further, the lumen 26 inside of the structural tube 14 functions to provide a pathway for delivering lubricant to the wrist pin of the piston including the wrist pin bearing surface 28 of the connecting rod.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A connecting rod for a reciprocating piston engine, comprising:
a body including an embedded structural tube for increasing stiffness of said connecting rod.

2. The connecting rod of claim 1, wherein said body includes a piston end, a crank shaft end and an intermediate section between said piston end and said crank shaft end.

3. The connecting rod of claim 2, wherein said structural tube extends from said piston end to said crank shaft end in said intermediate section.

4. The connecting rod of claim 3, wherein said structural tube includes a lumen having a diameter of between about 0.2 mm and about 2.0 mm.

5. The connecting rod of claim 3, wherein said structural tube has a Young's modulus Y₁, and said body has a Young's modulus Y₂ where Y₁ >Y₂.

6. The connecting rod of claim 5, wherein said Young's modulus Y₂ is between about 500 and 200 GPa.

7. The connecting rod of claim 6, wherein said structural tube is made from a ceramic.

8. The connecting rod of claim 7, wherein said ceramic is selected from a group consisting of ceramic oxides, ceramic non-oxides, composites and combinations thereof.

9. The connecting rod of claim 8, wherein said ceramic oxides are selected from a group consisting of aluminum oxide, beryllium oxide, cerium oxide, zirconium oxide, silicon oxide, quartz and mixtures thereof.

10. The connecting rod of claim 8, wherein said ceramic non-oxides are selected from a group consisting of carbide, boride, nitride, silicide and combinations thereof.

11. The connecting rod of claim 8, wherein said composite material includes a matrix binder and a reinforcing element selected from a group of materials consisting of reinforcing fibers, graphite fibers, glass fibers, carbon fibers, carbon nanotubes and combinations thereof.

12. The connecting rod of claim 8, wherein said body is made from a material selected from a group consisting of aluminum, aluminum alloy, iron, iron alloy, steel, tungsten alloy steel and combinations thereof.

13. A method of producing a connecting rod for a reciprocating piston engine, comprising:
forming a body of the connecting rod with an embedded structural tube thereby increasing stiffness of the connecting rod.

14. The method of claim 13, wherein said forming is by casting.

15. The method of claim 13, wherein said forming is by sintering.
